(19) United States
(12) Patent Application Publication
(10) Pub. No.: US 2012/0007027 A1
(43) Pub. Date: Jan. 12, 2012

(54) ACTIVATED CARBON BLACKS

(76) Inventors: Rudyard Lyle Istvan, Fort Lauderdale, FL (US); Stephen M. Lipka, Nicholasville, KY (US); Christopher Ray Swartz, Lexington, KY (US)

(21) Appl. No.: 12/987,794

(22) Filed: Jan. 10, 2011

(30) Foreign Application Priority Data
Jul. 9, 2010 (US) PCT/US2009/050084

(51) Int. Cl. H01B 1/04; B05D 1/12; C01B 31/10; C01B 31/08; B01J 21/18

(52) U.S. Cl. 252/502; 423/449.1; 502/439; 427/180

(57) ABSTRACT

Activated carbon blacks and the enhanced methods of preparing activated carbon blacks have been discovered. In order to form an activated carbon black, a conductive carbon black is coated with nanoparticles containing metal, and then catalytically activated in steam and an inert gas to form a catalytically activated mesoporous carbon black, where the mass of the catalytically activated carbon black is lower than the mass of the carbon black. The nanoparticles may serve as catalysts for activation rugosity of mesoporous carbon blacks. The catalytically activated carbon black material may be used in all manner of devices that contain carbon materials.

### RELATED APPLICATION

This application claims the benefit of U.S. Provisional Application No. 61/080,021, filed on Jul. 11, 2008, titled “Activated Carbon Blacks,” and PCT/US2009/050084, filed on Jul. 9, 2010, titled “Activated Carbon Blacks,” the contents of which are incorporated herein by reference.

### TECHNICAL FIELD

The present invention relates to activated carbon blacks and to methods for their preparation. The activated carbons blacks may be used in all manner of devices that may contain activated carbon materials, including but not limited to various electrochemical devices (e.g., capacitors, batteries, fuel cells, and the like), hydrogen storage devices, filtration devices, catalytic substrates, and the like.

### BACKGROUND OF THE INVENTION

In many emerging technologies, such as electric vehicles and hybrids thereof, there exists a need for capacitors with both high energy and high power densities. Much research has been devoted to this area, but for many practical applications such as hybrid electric vehicles, fuel cell powered vehicles, and electricity microgrids, the current technology is marginal or unacceptable in performance and too high in cost (See DOE Progress Report for Energy Storage Research and Development fy2005 (January 2006) and Utility Scale Electricity Storage by Gyuk, manager of the Energy Storage Research Program, DOE (speaker 4, slides 13-15, Advanced Capacitors World Summit 2006)).

Electrochemical double layer capacitors (EDLCs, a form of electrochemical capacitor called an ultracapacitor, sometimes also called a supercapacitor) are one type of capacitor technology that has been studied for such applications. Electrochemical double layer capacitor designs rely on very large electrode surface areas, which are usually made from “nanoscale rough” metal oxides or activated carbons coated on a current collector made of a good conductor such as aluminum or copper foil, to store charge by the physical separation of ions from a conducting electrolyte into a region known as the Helmholtz layer that forms immediately adjacent to the electrode surface (see U.S. Pat. No. 3,288,641). There is no distinct physical dielectric in an EDLC. Nonetheless, capacitance is still based on physical charge separation across an electric field. The electrodes on each side of the cell and separated by a porous membrane store identical but opposite ionic charges at their surfaces within the double layer, with the electrolyte solution in effect becoming the opposite plate of a conventional capacitor for both electrodes.

Most EDLC devices are symmetric carbon/carbon electrodes made from activated carbon particulate powder. One consideration in designing an EDLC is its equivalent series resistance (ESR). While a theoretically perfect capacitor has an ESR of zero, a higher equivalent series resistance may result in power loss due to resistive heating of the capacitor during charging or discharging. One method of lowering the ESR of the EDLC is to blend a small proportion of conductive carbon additive with the active carbon prior to forming the electrodes. This conductive additive is typically a carbon black, such as Black Pearls 2000 (available from Cabot Corp., Boston, Mass.) (see U.S. Pat. No. 6,643,119), but may also be a finely powdered graphite (see U.S. Pat. No. 5,706,165). Alternatively, a vapor grown carbon fibril (see U.S. Pat. No. 6,288,888) or pulverized agglomerates of sintered vapor grown carbon fibrils (see U.S. Pat. No. 6,103,373) may also be utilized.

Conductive additives are usually very fine (small) particles compared to the activated carbons they are blended with in order to enhance conductivity. For example, the primary particle size of a typical carbon black such as Vulcan XC72 (available from Cabot Corp., Boston, Mass.) or Ensaco 350G (available from Timcal Ltd., Bodio, Switzerland) is about 30 nm in diameter, and carbon black primary particles typically form small bonded aggregates varying up to a few hundreds of nanometers in dimension. A typical activated carbon particle such as BP-20 (also sold as RP-20, available from Kuraray Chemical Co., Ltd., Osaka, Japan), varies from 3 μm to 30 μm in diameter, with a D₅₀ of 8 μm (see U.S. Pat. No. 6,643,119). The conductive additives effectively “coat” the much larger activated carbon particles to enhance their overall particle-to-particle conductivity by increasing their total carbon-carbon contact surface. The smaller conductive particles provide additional conductive pathways between the larger particles. A preferred ratio of average conductive additive particle size to average activated carbon particle size may range from 1:5000 to 1:2 (see U.S. Pat. No. 7,268,995).

While conductive additives may lower the ESR of EDLC devices, conductive additives have other attributes that are undesirable in EDLC applications. For example, typical conductive additives do not contribute substantially to the overall capacitance of the EDLC. Activated carbons used in some EDLCs have specific capacitance ranging from about 80 F/g to 120 F/g. (see U.S. application Ser. No. 12/070,062, filed Feb. 14, 2008; see also P. Walmet, L. H. Hiltzik, E. D. Tolles, B. J. Craft and J. Muthu, MeadWestvaco, Charleston, S.C., USA, Electrochemical Performance of Activated Carbons Produced from Renewable Resources, Proceedings of the 16th International Seminar on Double-Layer Capacitors and Hybrid Energy Storage Devices, 581-607 (Deerfield Beach, Fla., Dec. 4-6, 2006)). In contrast, the specific capacitance of typical conductive additives is much lower. For example, Black Pearls 2000 has a specific capacitance of only 70.5 F/g in tetraethylammoniumtetrafluoroborate (TEA) in acetonitrile (AN) electrolyte (TEA/AN) (see Carbon 43: 1303-1310 (2005)). Ensaco 350G, another high surface conducive carbon black with a manufacturer's specified BET surface area of 770 m²/g, has a specific capacitance of only 67 F/g even after thermal activation (see Carbon 43: 1303-1310 (2005)). Without thermal activation, the specific capacitance of Ensaco 350G samples range between 54 F/g and 66 F/g in 1.8M triethylmethylammonium (TEMA) in propylene carbonate (PC) electrolyte (TEMA/PC). Other possible conductive additives have even lower specific capacitance. For example, the specific capacitance of Vulcan XC 72 is only 12.6 F/g (see Carbon 43: 1303-1310 (2005)). Therefore, to maximize gravimetric energy density, the amount of lower specific capacitance conductive additive blended with an activated carbon is minimized to at most a single digit percentage (see, for example U.S. Pat. No. 6,643,119, where a range of 1%-5% is preferred).

Another challenge in reducing the ESR of EDLCs while maintaining energy density is the void/volume ratio which results from polydisperse random packing of activated carbon particles. A typical void/volume ratio of an activated carbon is about 0.25 to 0.35 (see U.S. Pat. No. 6,103,373). Activated carbon particles are jagged and rough—technically, rugose, and irregular in shape so lacking sphericity). Thus, activated carbon particles random pack much less densely than equivalent smooth spheres. The inefficiency of random packing may be partly overcome by providing a polydispersion of activated carbon particles with a wide range of sizes (see U.S. Pat. No. 6,643,119). Although smaller activated carbon particles do pack into the voids between large activated carbon particles, their greater number and irregular nature result in increased grain boundary interface resistance (see U.S. Pub. No. 2007/0178310; see e.g. Sea Park, Chengdu Liang, Dai Sheng, Nancy Dudney, David DePaoli, Mesoporous Carbon Materials as Electrodes for Electrochemical Double-Layer Capacitor, Materials Research Society Symposium BB (Mobile Energy), Proceedings Volume 973E (Boston, Mass., Nov. 27-Dec. 1, 2006)). The increased grain boundary interface resistance contributes to a higher ESR in an EDLC.

As a result, electrocarbon suppliers offer air-classified material from which fines have been removed in order to lower ESR (see e.g., P. Walmet, L. H. Hiltzik, E. D. Tolles, B. J. Craft and J. Muthu, MeadWestvaco, Charleston, S.C., USA, Electrochemical Performance of Activated Carbons Produced from Renewable Resources, Proceedings of the 16th International Seminar on Double-Layer Capacitors and Hybrid Energy Storage Devices, 581-607, 592 (Deerfield Beach, Fla., Dec. 4-6, 2006)). Thus, it is difficult to further increase electrode macrodensity (lower the void/volume ratio) without increasing ESR. Stated another way, increasing volumetric energy density comes at the expense of power density, and in any event is limited by the natural packings of irregular activated carbon materials having micron scale average diameters.

A further outcome of the tradeoff between volumetric density and power density, and the limitation of the natural packing of activated carbon particles, is that the voids of the resulting activated carbon material are filled with more costly electrolyte than is required to cover the surface available for Helmholtz layer capacitance. In a typical device, sufficient electrolyte ions are available for full double layering of accessible carbon surfaces if the electrode particles are merely surface wetted with a film to the depth of a few solvated ions. For example, a coating of electrolyte less than 400 nm thick is more than sufficient, since each solvated ion is less than 2 nm, and by the basic physics of the double layer, with a 400 nm thick film there are ([400 nm/2 nm]*0.5) ions of the correct species (cationic or anionic) for either of the two electrodes in a device, or about 100 times more than the carbon's proximate exterior double layer can theoretically accommodate (see PCT App. No. PCT/US2007/0178310). The necessary porous separator within the EDLC also contains electrolyte, but itself contributes no capacitance. Thus, the porous separator represents an additional reservoir of electrolyte. Organic electrolyte is the single most expensive component of a typical ultracapacitor. Moreover, surplus electrolyte adds substantial cost and weight without enhancing capacitance.

It is desirable to tailor the electrode void/volume ratio to optimize cell performance (energy density and/or power density) while minimizing cost. The present means to do so are limited (see U.S. Pat. No. 7,268,995).

### BRIEF SUMMARY OF THE INVENTION

The scope of the present invention is defined solely by the appended claims, and is not affected to any degree by the statements within this summary.

In order to address these issues, there is a need for a conductive carbon additive with increased specific capacitance, that may be utilized to reduce the ESR of EDLCs, and that may improve volumetric energy density without lowering power density.

In one embodiment, there method of forming an activated carbon black. A carbon black is coated with nanoparticles. The carbon black is then catalytically activated in steam and an inert gas to form a catalytically activated carbon black. The mass of the catalytically activated carbon black is lower than the mass of the carbon black, and the activated carbon black is mesoporous. In one embodiment, the total mass loss of the carbon black after catalytic activation is greater than about 50%. In another embodiment, the activated carbon black has a specific capacitance of at least 80 F/g. In yet another embodiment, the activated carbon black has a specific capacitance of at least 110 F/g. In one embodiment, the carbon black comprises aggregates having at least one dimension of less than 1000 nanometers. In one embodiment, the nanoparticles comprise a metal or oxides thereof. In yet another embodiment, the nanoparticles comprise iron, nickel, zirconium, cobalt, titanium, ruthenium, osmium, rhodium, iridium, yttrium, palladium platinum, or combinations thereof or alloys thereof. In one embodiment, the nanoparticles comprise at least two metal oxides.

In another embodiment, there is a device containing an activated carbon, and a carbon black. In one embodiment, the specific capacitance of the activated carbon black is greater than 80 F/g, and in another embodiment, the specific capacitance of the activated carbon is also greater than 80 F/g. In another embodiment, the device is an electrochemical device, a capacitor, a hydrogen storage device, a filtration device, or a catalytic substrate. In one embodiment, the proportion of activated carbon to activated carbon black is less than 10:1.

In one embodiment, there is a device comprising an activated carbon black with specific capacitance greater than 80 F/g. In another embodiment, the device is an electrochemical device, a capacitor, a hydrogen storage device, a filtration device, or a catalytic substrate.

### BRIEF DESCRIPTION OF THE DRAWINGS

FIG. 1 is a graph showing a cyclic voltammogram of a carbon black compared with carbon black samples steam activated for 30 and 60 minutes.

FIG. 2 is a graph showing a voltage versus time constant current charge discharge test of a carbon black sample compared with carbon black samples steam activated for 30 and 60 minutes.

FIG. 3 is a graph comparing discharge capacitance of a carbon black with carbon black samples steam activated for 30 and 60 minutes, and carbon black samples coated with nickel acetylacetonate, or iron acetylacetonate followed by steam activation for 30 and 60 minutes, and carbon black samples coated with varying concentrations of zirconium acetylacetonate, followed by steam activation for 60 minutes.

FIG. 4 is a graph showing a cyclic voltammogram of a carbon black compared with carbon black samples coated with nickel acetylacetonate followed by steam activation for 30 and 60 minutes.

FIG. 5 is a graph showing a cyclic voltammogram of a carbon black compared with carbon black samples coated with iron acetylacetonate followed by steam activation for 30 and 60 minutes.

FIG. 6 is a graph showing a cyclic voltammogram of a carbon black compared with carbon black samples coated with zirconium acetylacetonate of varying concentration, followed by steam activation for 60 minutes.

FIG. 7 is a graph showing cyclic voltammograms of a carbon black sample coated with iron acetylacetonate followed by steam activation for 60 minutes.

FIG. 8 is a graph showing a cyclic voltammogram of an activated carbon blended with graphite, compared with an activated carbon blended with an activated carbon black.

### DETAILED DESCRIPTION OF THE INVENTION

Activation of conductive carbon blacks utilizing methods of engineered nanoparticle deposition has been discovered and is described herein. The activated carbon blacks may be utilized in ELDCs to reduce ESR, improve volumetric energy density without lowering power density, and reduce the amount of surplus electrolyte used.

Previous patent applications by these inventors increased a carbon's usable surface by activation processes including surface coated catalytic nanoparticles. Specifically, general nanoparticle catalytic activation methods enhancing the rugosity and proximate exterior of carbon materials have been described in U.S. patent application Ser. No. 11/211,894, filed Aug. 5, 2005, and U.S. patent application Ser. No. 12/070,062, filed Feb. 14, 2008, the entire contents of each are incorporated herein by reference, except that in the event of any inconsistent disclosure or definition from the present application, the disclosure or definition herein shall be deemed to prevail.

These nanoparticle catalytic activation processes may also be used to activate a wide range of conductive carbon blacks, such as carbon blacks used typically as conductive additives in EDLCs. The use of activated conductive carbon blacks in ELDCs may overcome several tradeoffs associated with utilizing carbon blacks in EDLCs. Activated conductive carbon black additives may have the same or greater specific capacitance than the activated carbons they are blended with to construct an EDLC. Thus, gravimetric capacitance may not decrease as the proportion of activated conductive carbon black used in the EDLC is increased.

Moreover, because of relatively smaller size of conductive/capacitive activated carbon black particles compared with activated carbon particles, the activated carbon black particles may be added in arbitrary amounts to intentionally fill voids in activated carbon material, thereby reducing the void/volume ratio of an electrode to any desired optimum without increasing ESR or decreasing gravimetric energy density. By filling voids with activated carbon black material, it may be possible to increase volumetric energy density and also reduce the quantity of electrolyte that fills voids but which is otherwise more than is required for Helmholtz layer capacitance. Thus, activated carbon blacks may simultaneously increase conductivity, increase volumetric energy density, and reduce surplus electrolyte.

Throughout this description and in the appended claims, the following definitions are to be understood:

### DEFINITIONS

The term “rugosity” used in reference to carbons refers to the difference between actual surface area and theoretical geometric area in accordance with the definition in the IUPAC Compendium of Chemical Terminology, 2^{nd} edition (1997). For example, the sand side of a sheet of ordinary sandpaper has substantially higher rugosity than the paper side.

The term “particle” used in reference to precursors and activated carbons refers to a distribution of materials conventionally from about 1 micron to more than 100 microns in diameter. Such particles can be conventionally prepared prior to and/or after physical or chemical activation, as described, for example, in U.S. Pat. No. 5,877,935, U.S. Pat. No. 6,643,119 and U.S. Pat. No. 7,214,646.

The term “carbon black” used in reference to carbon blacks and activated carbon blacks refers to a colloidal carbon material in the form of approximate spheres and of their fused aggregates with sizes below 1000 nm, where a colloidal carbon is a particulate carbon with particle sizes below ca. 1000 nm in at least one dimension, according to the IUPAC Compendium of Chemical Terminology, 2^{nd} edition, 1997.

The term “carbon black particle” used in reference to carbon blacks and activated carbon blacks refers to a distribution of fused aggregates conventionally below ca. 1000 nm in at least one dimension.

The phrase “fiber” used in reference to polymers and carbons refers to filamentous material of fine diameter, such as diameters less than about 20 microns, and preferably less than about 10 microns. Such fibers can be obtained using conventional solvent or melt spinning processes or by unconventional spinning processes such as electrospinning. Such fibers, when fragmented into short pieces (as with conventional ‘milled’ carbon fiber at about 150 microns length with aspect ratios of 15 to 30 from fiber diameters conventionally at least 7 microns), as used herein also comprise ‘particles’.

The term “mesoporous” as used in reference to a carbon describes a distribution of pore sizes wherein at least about 20% of the total pore volume has a size from about 2 nm to about 50 nm in accordance with the standard IUPAC definition.

The phrase “catalytically activated” as used in reference to a carbon refers to its porous surface wherein mesopores have been formed from the external surface of the carbon black particle, carbon particle, or carbon fiber toward the interior by a catalytically controlled differential activation (e.g., etching) process. In some embodiments, metal and/or metal oxide particles of a chosen average size serve as suitable catalysts and a least a portion of the metal oxides remain in or on the carbon after the activation process.

The phrase “nanoparticle” as used in reference to catalytic particles means a nanoscale material with an average particle diameter greater than 2 nm and less than 100 nm.

There are a variety of design considerations when manufacturing an activated carbon for use in an EDLC. One factor is the grain boundary resistance of the activated carbon material. As grain boundary resistance increases, the equivalent series resistance (ESR) of the resulting EDLC using the activated carbon may also increase. One method of lowering the grain boundary resistance, and thus the equivalent series resistance (ESR) of the EDLC, is to blend a small proportion of conductive carbon additive, such as a carbon black, with the active carbon prior to forming the electrodes.

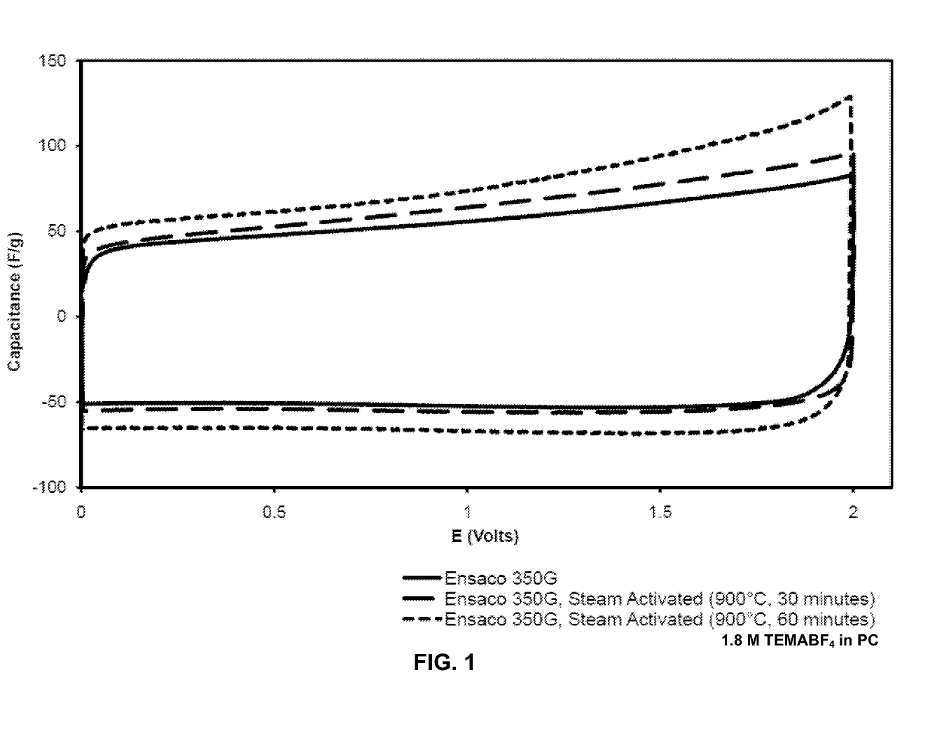

FIG. 1 is a graph showing a cyclic voltammogram of a carbon black compared with carbon black samples that are steam activated for 30 and 60 minutes at 900° C. In one embodiment, during the steam activation, nitrogen is flowed through the furnace to purge or remove air. The nitrogen purge continues as the water is injected into the furnace. The water is introduced into the furnace using a metering pump. The nitrogen flow rate is held at about 200 mL/min and the water injection rate is held at approximately between 150 and 175 mL/h. This steam activation may also be referred to as 30% steam activation, where 30% is the approximate molecular weight fraction of water (steam) flowed through the furnace as a proportion of the total gas flow.

As shown in FIG. 1, Ensaco 350G, a high surface conducive carbon black with a manufacturer's specified BET surface area of 770 m²/g (and measured BET surface between 650-790 m²/g), has a specific capacitance of only 54 F/g in 1.8M triethylmethylammonium tetrafluoroborate (TEMABF₄) in propylene carbonate (PC) electrolyte, as shown in FIG. 1. Thermal activation does not significantly improve specific capacitance. After 30 minutes of activation in steam at 900° C., the specific capacitance of the Ensaco 350G sample improves to 59.8 F/g in 1.8M TEMABF₄ in PC electrolyte. The measured specific capacitance of another Ensaco 350G sample activated for 60 minutes in steam at 900° C. is 66 F/g in 1.8M TEMABF₄ in PC electrolyte. This result for 60 minutes of activation of Ensaco 350G in steam is similar to a 67 F/g result reported in Carbon 43: 1303-1310 (2005) for an Ensaco 350G sample activated under other physical conditions.

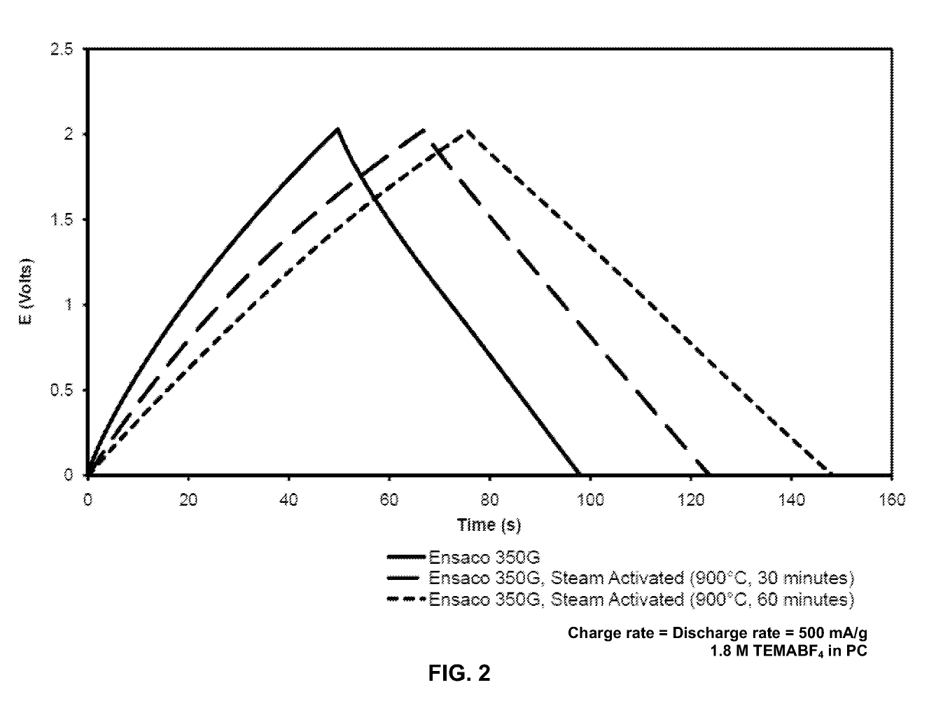

FIG. 2 is a graph showing a voltage versus time constant current charge/discharge test of a carbon black sample compared with carbon black samples that are steam activated for 30 and 60 minutes following the same steam activation procedure described in the text accompanying FIG. 1.

A current charge/discharge test may be utilized to determine the discharge capacitance of a sample, and may provide a more accurate picture of how a device will operate. In an actual application, the capacitor may be charged and discharged at constant current to a given voltage. The resistive voltage drop can be measured directly from the data, and the waveforms typically have a linear slope (linear charge/discharge profile) for pure electrical double layer charge storage. Discharge capacitance may be determined from the current load used in the experiment, mass of the sample, and the slope of the waveforms using the following formula:

i=C(dv/dt)

In the formula, “i” is the current, C is the capacitance of the sample, and dv/dt is the change in voltage divided by the change in time. As shown in FIG. 2, Ensaco 350G has a discharge capacitance of only 46.5 F/g in 1.8M TEMABF₄ in PC electrolyte. After 30 minutes of activation in steam at 900° C., the discharge capacitance of the Ensaco 350G sample improves to 55.8 F/g in 1.8M TEMABF₄ in PC electrolyte. The measured discharge capacitance of another Ensaco 350G sample activated for 60 minutes in steam at 900° C. is 72.2 F/g in 1.8M TEMABF₄ in PC electrolyte.

The specific capacitance (and thus discharge capacitance) of Ensaco 350G may be lower than the specific capacitance of many activated carbon materials utilized in ELDCs. For example, some activated carbons have specific capacitance ranging from about 80 F/g to 120 F/g (see U.S. application Ser. No. 12/070,062, filed Feb. 14, 2008; see also P. Walmet, L. H. Hiltzik, E. D. Tolles, B. J. Craft and J. Muthu, MeadWestvaco, Charleston, S.C., USA, Electrochemical Performance of Activated Carbons Produced from Renewable Resources, Proceedings of the 16th International Seminar on Double-Layer Capacitors and Hybrid Energy Storage Devices, 581-607 (Deerfield Beach, Fla., Dec. 4-6, 2006)). The gravimetric capacitance of an activated carbon combined with Ensaco 350G, as supplied by the manufacturer, or thermally activated, is lower than the gravimetric capacitance of the activated carbon. Thus, without an activation technique to improve the specific capacitance of carbon black material, the proportion of carbon black used in an EDLC should be about the minimum required to reduce ESR to a desired value, as increased proportions of carbon black lower the gravimetric energy density of an EDLC.

Previous patent applications by these inventors increased a carbon's usable surface, and thus, its specific capacitance, by activation processes including surface coated catalytic nanoparticles. Specifically, general nanoparticle catalytic activation methods enhancing the rugosity and proximate exterior of carbon materials have been described in U.S. patent application Ser. No. 11/211,894, filed Aug. 5, 2005, and U.S. patent application Ser. No. 12/070,062, filed Feb. 14, 2008. Similar techniques may be utilized to increase the usable surface, and thus, the specific capacitance, of a carbon black.

In some embodiments, a metal-containing material, such as a metal oxide nanoparticle or a precursor thereto, is introduced during one or more of the processing stages to provide catalytic surface sites for the subsequent etching of surface pores during the activating stage and/or to provide a desired electrochemical activity. The metal or metals of the metal containing materials are selected based on their catalytic and/or electrochemical activities.

In some embodiments, the nanoparticles have diameters of up to and including about 50 nm, in other embodiments, up to and including about 15 nm, in other embodiments, up to and including about 8 nm, in other embodiments, up to and including about 4 nm, and in other embodiments, about 2 nm. The preferred nanoparticle size mode will depend on the choice of electrolyte and the device requirements, and the typical size of an individual carbon black particle or carbon particle that the nanoparticles are being deposited on. For example power density may preferably have larger surface mesopores to reduce diffusion and migration hindrance and local depletion, at the expense of less total surface and lower energy density.

It is generally accepted that EDLC pore size should be at least about 1-2 nm for an aqueous electrolyte or about 2-3 nm for an organic electrolyte to accommodate the solvation spheres of the respective electrolyte ions in order for the pores to contribute surface available for Helmholtz layer capacitance. Pores also should be open to the surface for electrolyte exposure and wetting, rather than closed and internal. At the same time, the more total open pores there are just above this threshold size the better, as this maximally increases total surface area. Substantially larger pores are undesirable because they comparatively decrease total available surface.

In some embodiments, the metal and/or metal oxide nanoparticles comprise iron, nickel, zirconium, cobalt, titanium, ruthenium, osmium, rhodium, iridium, yttrium, palladium, or platinum, or combinations thereof, or alloys thereof. In some embodiments, the metal/oxide nanoparticles comprise nickel oxide. In some embodiments, the metal/oxide nanoparticles comprise iron oxide. In some embodiments, the nanoparticles comprise alloys of nickel, iron, and zirconium.

Carbon black mesoporosity and total surface resulting from catalytic nanoparticle activation is a function of metal or metal oxide type (catalytic potency), nanoparticle size, nanoparticle loading (i.e. the coverage on the carbon black, the number of nanoparticles per unit carbon black exterior surface), carbon precursor, and carbon black activation conditions such as temperature, etchant gas (i.e. steam or carbon dioxide or air) content as a percentage of the neutral (e.g. nitrogen) atmosphere, and duration of activation.

A metal-containing material may be introduced using an organometallic metal oxide precursor or a mixture of such precursors. In one embodiment, the metal oxide precursor preferably comprises a metal acetylacetonate, such as nickel acetylacetonate, iron acetylacetonate, or zirconium acetylacetonate. In another example, the metal oxide precursor comprises metal acetate with an alcohol as a solvent, such as nickel acetate.

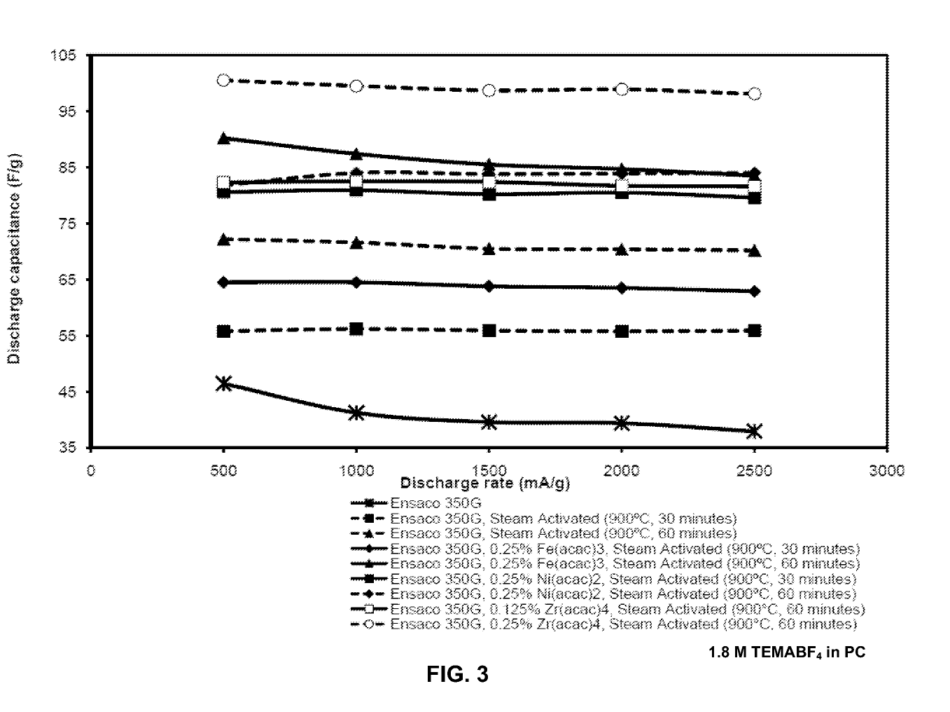

FIG. 3 is a graph comparing discharge capacitance of a carbon black with carbon black samples steam activated for 30 and 60 minutes, and carbon black samples coated with nickel acetylacetonate, or iron acetylacetonate followed by steam activation for 30 and 60 minutes, and carbon black samples coated with varying concentrations of zirconium acetylacetonate, followed by steam activation for 60 minutes.

In the experiment, nanoparticles are formed by solvent deposition of 0.25% (metal:carbon weight) metal (iron or nickel) acetylacetonate dissolved in tetrahydrofuran (THF) onto the Ensaco 350G carbon black samples, followed by evaporation of the solvent and then metal oxide nanoparticle and catalytic mesopore formation using a steam activation at 900° C. for 30 or 60 minutes. The experiment nanoparticles are formed by solvent deposition of 0.125% or 0.25% (metal:carbon weight) metal (zirconium) acetylacetonate dissolved in tetrahydrofuran (THF) onto the Ensaco 350G carbon black samples, followed by evaporation of the solvent and then metal oxide nanoparticle and catalytic mesopore formation using a steam activation at 900° C. 60 minutes. In one embodiment, during the steam activation, nitrogen is flowed through the furnace to purge or remove air. The nitrogen purge continues as the water is injected into the furnace. The water is introduced into the furnace using a metering pump. The nitrogen flow rate is held at about 200 mL/min and the water injection rate is held at approximately between 150 and 175 mL/h. This steam activation may also be referred to as 30% steam activation, where 30% is the approximate molecular weight fraction of water (steam) flowed through the furnace as a proportion of the total gas flow.

These results are compared with a sample of Ensaco 350G as delivered from the manufacturer (no activation), and Ensaco 350G samples activated in steam at 900° C. for 30 and 60 minutes, as performed in the experiments described in the text accompanying FIGS. 1 and 2. A comparison of the measured discharge capacitance is shown in FIG. 3 and Table 1.

TABLE 1

| | Discharge Capacitance (F/g) | | | | | |
|---|---|---|---|---|---|---|
| | Discharge Rate mA/g | | | | | |
| Sample | 500 | 1000 | 1500 | 2000 | 2500 | Average |
| Ensaco 350G | 46.5 | 41.3 | 39.6 | 39.4 | 38.0 | 40.9 |
| Ensaco 350G, | 55.8 | 56.2 | 55.9 | 55.8 | 55.9 | 55.9 |
| 30 min. | | | | | | |
| Steam at 900° C. | | | | | | |
| Ensaco 350G, 60 | 72.2 | 71.6 | 70.5 | 70.4 | 70.2 | 71.0 |
| min. | | | | | | |
| Steam at 900° C. | | | | | | |
| Ensaco 350G, | 64.5 | 64.5 | 63.8 | 63.5 | 62.9 | 63.8 |
| 0.25% Fe(acac)₃, | | | | | | |
| 30 min. | | | | | | |
| Steam at 900° C. | | | | | | |
| Ensaco 350G, | 90.2 | 87.4 | 85.5 | 84.7 | 83.5 | 86.3 |
| 0.25% Fe(acac)₃, | | | | | | |
| 60 min. | | | | | | |
| Steam at 900° C. | | | | | | |
| Ensaco 350G, | 80.6 | 80.9 | 80.2 | 80.5 | 79.6 | 80.4 |
| 0.25% Ni(acac)₂, | | | | | | |
| 30 min. | | | | | | |
| Steam at 900° C. | | | | | | |
| Ensaco 350G, | 81.8 | 84.0 | 83.8 | 83.9 | 84.0 | 83.5 |
| 0.25% Ni(acac)₂, | | | | | | |
| 60 min. | | | | | | |
| Steam at 900° C. | | | | | | |
| Ensaco 350G, | 82.3 | 82.5 | 82.4 | 81.7 | 81.6 | 82.1 |
| 0.125% Zr(acac)₄, | | | | | | |
| 60 min. | | | | | | |
| Steam at 900° C. | | | | | | |
| Ensaco 350G, | 100.5 | 99.5 | 98.7 | 98.9 | 98.1 | 99.1 |
| 0.25% Zr(acac)₄, | | | | | | |
| 60 min. | | | | | | |
| Steam at 900° C. | | | | | | |

Comparison of the average discharge capacitance results shows that activation of conductive carbon blacks utilizing methods of engineered nanoparticle deposition produces activated carbon blacks with substantially higher discharge capacitance (and hence, specific capacitance) than non-activated or steam activated carbon black samples. Further, the average discharge capacitance of the activated carbon black samples is comparable to the discharge capacitance of activated carbons.

While the average discharge capacitance may indicate that activation using various types of metal nanoparticles produces similar results, other factors may be considered when determining the process utilized to manufacture an activated carbon black. For example, the reactivity of the nanoparticles deposited may affect mass loss caused by the activation, as illustrated in Table 5 and the accompanying text. In the experiments summarized in FIG. 3 and Table 1, carbon black mass loss for nickel nanoparticle activation is greater than carbon black mass loss for iron nanoparticle activation, because the nickel nanoparticles are more reactive. Mass loss associated with activation increases the cost per kilogram of manufacturing an activated carbon black. Thus, activation using deposited iron nanoparticles may be more cost effective and may produce a similar specific capacitance result. On the other hand, if a metal-containing material is not reactive enough, the time required to activate a carbon black (and thus manufacture the activated carbon black) may increase, thereby increasing the cost per kilogram.

The cost of the metal-containing materials used to provide catalytic surface sites for surface pore etching during activation is another consideration. If zirconium is less expensive than a similar quantity of nickel, then the cost of a carbon black activated with nanoparticles containing zirconium may be comparatively cheaper than a carbon black activated with nanoparticles containing nickel. Further, the quantity of metal-containing materials used to provide catalytic surface sites for surface pore etching during activation is yet another consideration. For example, Table 1 shows that a lower concentration (0.125%) of zirconium acetylacetonate may result in an activated carbon black with similar specific capacitance as a carbon black activated using a higher concentration of nickel acetylacetonate. Using less metal-containing material may reduce the cost of the manufactured activated carbon black. Other factors that may impact the choice of activation process include the carbon black starting material and the electrolyte used in the manufactured capacitor.

As previously noted, carbon black mesoporosity and total surface resulting from catalytic nanoparticle activation is a function of many factors, including metal or metal oxide type, nanoparticle size, nanoparticle loading (i.e. the coverage on the carbon black, the number of nanoparticles per unit carbon black exterior surface), carbon precursor, and carbon black activation conditions such as temperature, etchant gas (i.e. steam or carbon dioxide or air) content as a percentage of the neutral (e.g. nitrogen) atmosphere, and duration of activation. Further, other activation processes, such as sequential activation processes disclosed in U.S. patent application Ser. No. 12/070,062, may also be utilized to improve the mesoposity and total surface area of the activated carbon black. Some or all of these process parameters may be adjusted to produce activated carbon blacks with similar or enhanced characteristics as the embodiments described in Table 1 and FIG. 3.

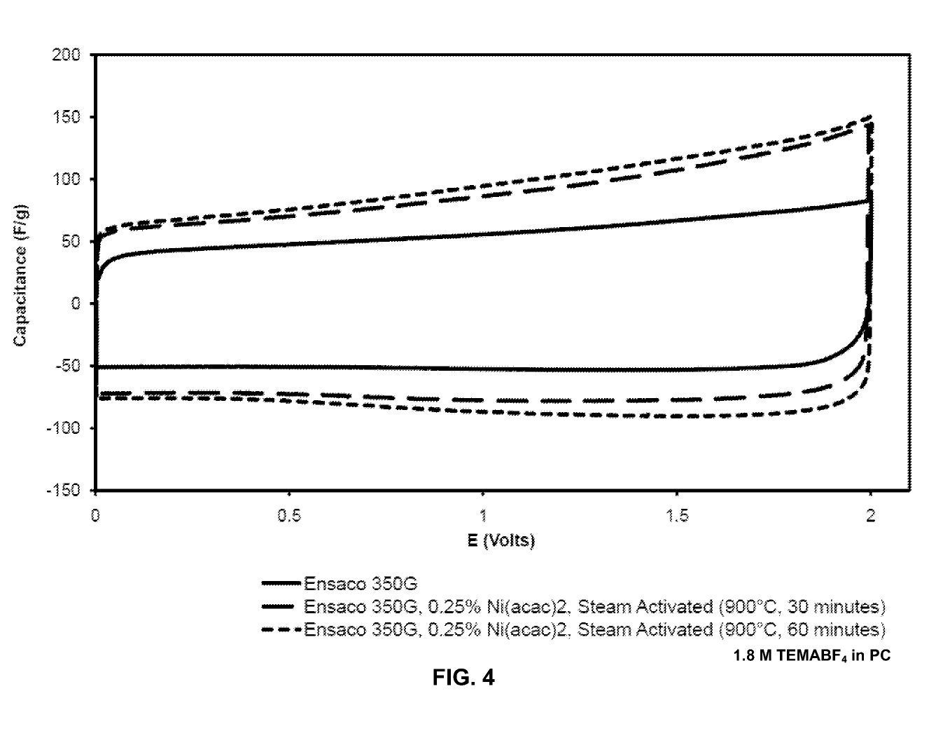

FIG. 4 is a graph showing a cyclic voltammogram of a carbon black compared with carbon black samples coated with nickel acetylacetonate followed by steam activation for 30 and 60 minutes. In one embodiment, nanoparticles of nickel are formed by solvent deposition of 0.25% (metal:carbon weight) nickel acetylacetonate dissolved in tetrahydrofuran (THF) onto the Ensaco 350G carbon black samples, followed by evaporation of the solvent and then initial metal oxide nanoparticle and catalytic mesopore formation using a steam activation at 900° C. for 30 and 60 minutes. In one embodiment, during the steam activation, nitrogen is flowed through the furnace to purge or remove air. The nitrogen purge continues as the water is injected into the furnace. The water is introduced into the furnace using a metering pump. The nitrogen flow rate is held at about 200 mL/min and the water injection rate is held at approximately between 150 and 175 mL/h. This steam activation may also be referred to as 30% steam activation, where 30% is the approximate molecular weight fraction of water (steam) flowed through the furnace as a proportion of the total gas flow. Specific capacitance results for each sample as measured in using 1.8M TEMABF₄ in PC electrolyte are shown in Table 2.

TABLE 2

| | | Ensaco 350G, | Ensaco 350G, |
|---|---|---|---|
| | | 0.25% Ni(acac)₂ | 0.25% Ni(acac)₂ |
| | Ensaco 350G, | in THF, 30 min. | in THF, 60 min. |
| | as received | Steam at 900° C. | Steam at 900° C. |
| Specific | 54.1 F/g | 82.1 F/g | 91.0 F/g |
| Capacitance | | | |
| (1 V) | | | |
| Specific | 60.0 F/g | 92.8 F/g | 103.4 F/g |
| Capacitance | | | |
| (1.5 V) | | | |

Comparison of the specific capacitance results shows that activation of conductive carbon blacks utilizing methods of engineered deposition of nickel nanoparticles produces activated carbon blacks with substantially higher specific capacitance than the non-activated (“as received”) carbon black samples.

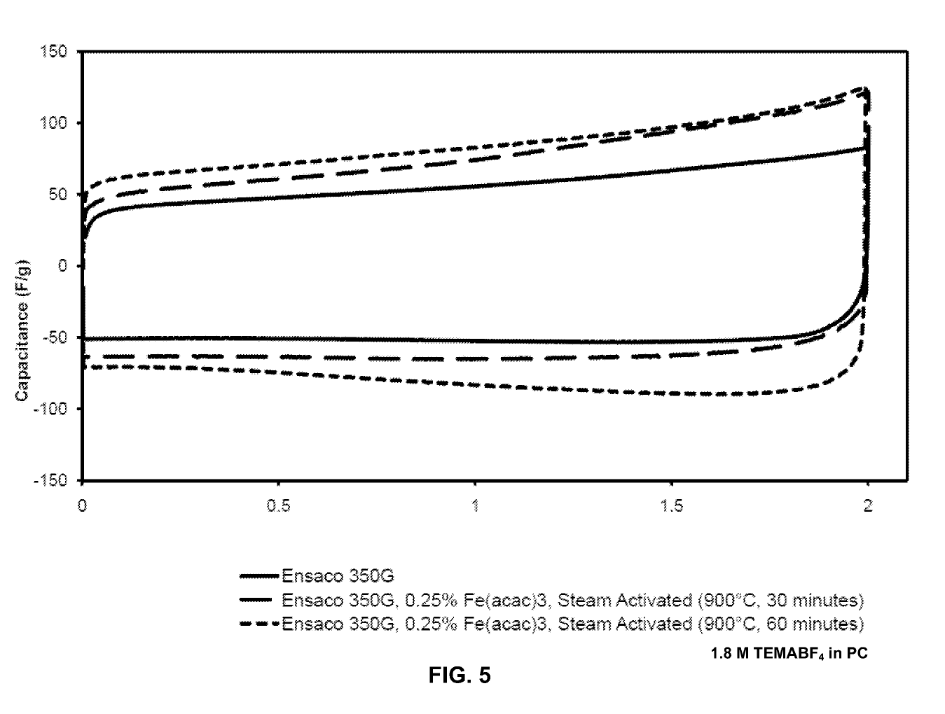

FIG. 5 is a graph showing a cyclic voltammogram of a carbon black compared with carbon black samples coated with iron acetylacetonate followed by steam activation for 30 and 60 minutes. In one embodiment, nanoparticles of iron are formed by solvent deposition of 0.25% (metal:carbon weight) iron acetylacetonate dissolved in tetrahydrofuran (THF) onto the Ensaco 350G carbon black samples, followed by evaporation of the solvent and then initial metal oxide nanoparticle and catalytic mesopore formation using a steam activation at 900° C. for 30 and 60 minutes. In one embodiment, during the steam activation, nitrogen is flowed through the furnace to purge or remove air. The nitrogen purge continues as the water is injected into the furnace. The water is introduced into the furnace using a metering pump. The nitrogen flow rate is held at about 200 mL/min and the water injection rate is held at approximately between 150 and 175 mL/h. This steam activation may also be referred to as 30% steam activation, where 30% is the approximate molecular weight fraction of water (steam) flowed through the furnace as a proportion of the total gas flow. Specific capacitance results for each sample as measured in using 1.8M TEMABF₄ in PC electrolyte are shown in Table 3.

TABLE 3

| | | Ensaco 350G, | Ensaco 350G, |
|---|---|---|---|
| | | 0.25% Fe(acac)₃ | 0.25% Fe(acac)₃ |
| | Ensaco 350G, | in THF, 30 min. | in THF, 60 min. |
| | as received | Steam at 900° C. | Steam at 900° C. |
| Specific | 54.1 F/g | 69.6 F/g | 83.0 F/g |
| Capacitance | | | |
| (1 V) | | | |
| Specific | 60.0 F/g | 78.3 F/g | 93.1 F/g |
| Capacitance | | | |
| (1.5 V) | | | |

Comparison of the specific capacitance results shows that activation of conductive carbon blacks utilizing methods of engineered deposition of iron nanoparticles produces activated carbon blacks with substantially higher specific capacitance than non-activated (“as received”) carbon black samples.

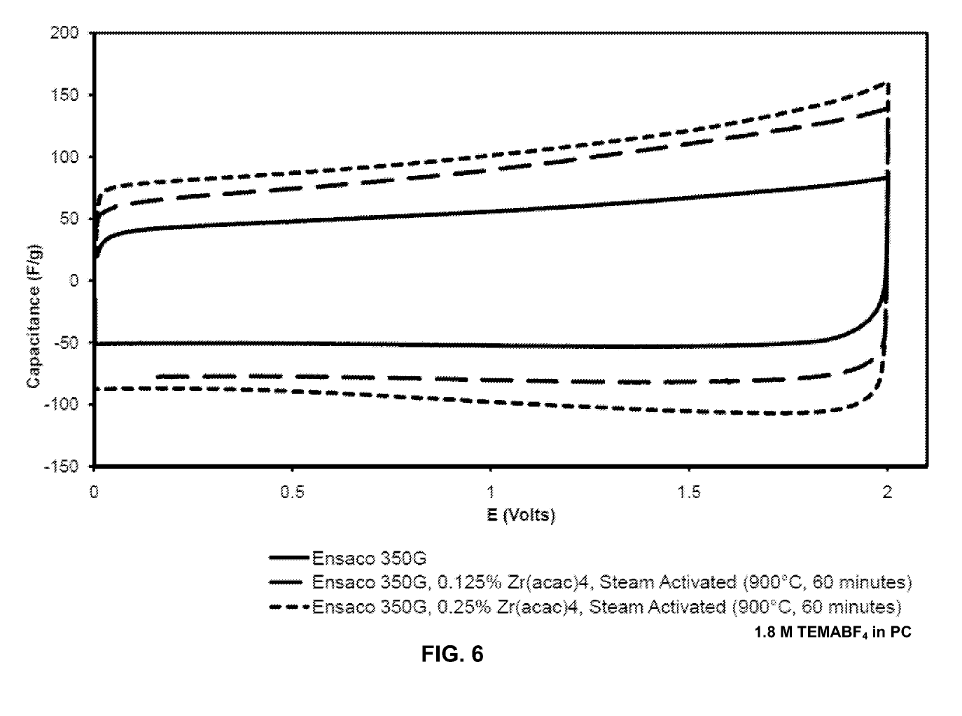

FIG. 6 is a graph showing a cyclic voltammogram of a carbon black compared with carbon black samples coated with zirconium acetylacetonate of varying concentration, followed by steam activation for 60 minutes. In one embodiment, nanoparticles of zirconium are formed by solvent deposition of 0.125% or 0.25% (metal:carbon weight) zirconium acetylacetonate dissolved in tetrahydrofuran (THF) onto the Ensaco 350G carbon black samples, followed by evaporation of the solvent and then initial metal oxide nanoparticle and catalytic mesopore formation using a steam activation at 900° C. for 60 minutes. In one embodiment, during the steam activation, nitrogen is flowed through the furnace to purge or remove air. The nitrogen purge continues as the water is injected into the furnace. The water is introduced into the furnace using a metering pump. The nitrogen flow rate is held at about 200 mL/min and the water injection rate is held at approximately between 150 and 175 mL/h. This steam activation may also be referred to as 30% steam activation, where 30% is the approximate molecular weight fraction of water (steam) flowed through the furnace as a proportion of the total gas flow. Specific capacitance results for each sample as measured in using 1.8M TEMABF₄ in PC electrolyte are shown in Table 4.

TABLE 4

| | | Ensaco 350G, | Ensaco 350G, |
|---|---|---|---|
| | | 0.125% Fe(acac)₃ | 0.25% Fe(acac)₃ |
| | Ensaco 350G, | in THF, 60 min. | in THF, 60 min. |
| | as received | Steam at 900° C. | Steam at 900° C. |
| Specific | 54.1 F/g | 84.9 F/g | 99.4 F/g |
| Capacitance | | | |
| (1 V) | | | |
| Specific | 60.0 F/g | 96.0 F/g | 113.4 F/g |
| Capacitance | | | |
| (1.5 V) | | | |

Comparison of the specific capacitance results shows that activation of conductive carbon blacks utilizing methods of engineered deposition of iron nanoparticles produces activated carbon blacks with substantially higher specific capacitance than non-activated (“as received”) carbon black samples.

Table 5 illustrates the changes in carbon black characteristics relevant to EDLCs, caused by activation of a carbon black utilizing methods of engineered nanoparticle deposition. Pore volume and distribution values are obtained using a standard nitrogen gas adsorption instrument. Specific surface area is calculated using the DFT (Density Functional Theory) method.

TABLE 5

| | | Ensaco 350G, | Ensaco 350G, |
|---|---|---|---|
| | | 0.25% Fe(acac)₃ | 0.25% Zr(acac)₄ |
| | Ensaco 350G, | in THF, 60 min. | in THF, 60 min. |
| | as received | Steam at 900° C. | Steam at 900° C. |
| Wt. loss (%) | n/a | 58.8 | 84.0 |
| S_{DFT} (m²/g) | 643 | 1013 | 1508 |
| Total Pore | 1.022 | 2.040 | 2.1015 |
| Volume (cm³/g) | | | |
| Pore Size | 70 | 49.8 | 6.9 |
| Distribution: | | | |
| micropore (%) | | | |
| Pore Size | 30 | 50.2 | 75.9 |
| Distribution: | | | |
| mesopore (%) | | | |
| Pore Size | 0 | 0 | 17.2 |
| Distribution: | | | |
| macropore (%) | | | |

As shown in Table 5, catalytic nanoparticle activation of an Ensaco 350G carbon black increases specific surface area (S_{DFT}) by over 50%, approximately doubles pore volume, and increases the percentage of useful mesopores for Helmholtz layer capacitance. Each of these changes may contribute to the improved specific capacitance results observed in the experiments described in FIGS. 3-6 and the accompanying descriptions. Comparison of the results shown in Table 5 and the discharge capacitance shown in Table 1 further demonstrates that the selected action process impacts the properties of the manufactured activated carbon black.

Table 5 also shows substantial mass loss due to activation of the Ensaco 350G carbon black material. The activation mass loss may vary depending on the metal acetylacetonate species used (such as nickel, iron, or zirconium), the carbon black material, and the activation conditions. In another experiment not shown in Table 5, nanoparticles of nickel are formed by solvent deposition of 0.25% (metal:carbon weight) nickel acetylacetonate dissolved in tetrahydrofuran (THF) onto Ensaco 350G carbon black samples, followed by evaporation of the solvent and then initial metal oxide nanoparticle and catalytic mesopore formation using a steam activation at 900° C. for 60 minutes. In this experiment, average mass loss was 81.6%, which is substantially greater than the 58.8% mass loss associated with the iron acetylacetonate activation experiment shown in Table 5. Therefore, while the specific capacitance of the resulting activated carbon material may be a consideration, the cost per kilogram of activated carbon black may be an additional design consideration. Mass loss associated with activation increases the cost per kilogram of manufacturing an activated carbon black.

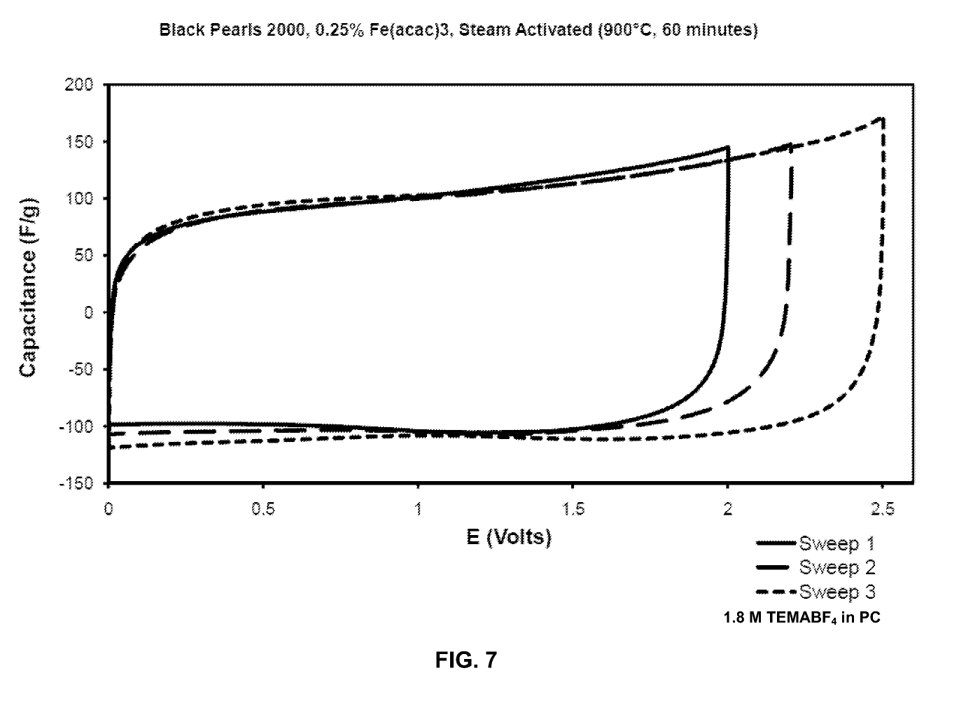

Other carbon black starting materials may be activated using utilizing similar methods of engineered deposition of metal nanoparticles, with comparable or improved results. FIG. 7 is a graph showing cyclic voltammograms of a carbon black sample coated with iron acetylacetonate, followed by steam activation for 60 minutes. In one embodiment, nanoparticles of iron are formed by solvent deposition of 0.25% (metal:carbon weight) iron acetylacetonate dissolved in tetrahydrofuran (THF) onto a sample of Black Pearls 2000, followed by evaporation of the solvent and then initial metal oxide nanoparticle and catalytic mesopore formation using a steam activation at 900° C. for 60 minutes. In one embodiment, during the steam activation, nitrogen is flowed through the furnace to purge or remove air. The nitrogen purge continues as the water is injected into the furnace. The water is introduced into the furnace using a metering pump. The nitrogen flow rate is held at about 200 mL/min and the water injection rate is held at approximately between 150 and 175 mL/h. This steam activation may also be referred to as 30% steam activation, where 30% is the approximate molecular weight fraction of water (steam) flowed through the furnace as a proportion of the total gas flow. The mass loss associated with the activation is about 79%.

In one embodiment, a sample electrode is formed comprising 94 wt. % activated carbon black, 3 wt. % KS6 graphite, and 3 wt. % Teflon PTFE 6C binder. (Teflon PTFE 6C is available from DuPont Corporation, Wilmington, Del.) The specific capacitance of the sample as shown in FIG. 7 is 102.8 F/g at 1.0 V, and 110.6 F/g at 1.5 V, as measured in 1.8M TEMABF₄ in PC electrolyte. In comparison, non-activated Black Pearls 2000 has a specific capacitance of only 70.5 F/g in TEA/AN electrolyte. The increase in specific capacitance is generally attributable to the activation of the carbon black, and not the different electrolyte utilized in the comparative example (see P. Walmet, L. H. Hiltzik, E. D. Tolles, B. J. Craft and J. Muthu, MeadWestvaco, Charleston, S.C., USA, Electrochemical Performance of Activated Carbons Produced from Renewable Resources, Proceedings of the 16th International Seminar on Double-Layer Capacitors and Hybrid Energy Storage Devices, 581-607, 595 (slide 15) (Deerfield Beach, Fla., Dec. 4-6, 2006), showing that the capacitance of several materials in TEMABF₄ in PC electrolyte is approximately equal to the capacitance of the same materials in TEA/AN electrolyte).

The KS6 graphite in this embodiment may contribute to a reduced ESR, but an electrode may not require KS6 graphite, because carbon black or activated carbon black may be utilized to reduce ESR. Therefore, in another embodiment, an electrode may be formed utilizing a lower percentage of graphite. In yet another embodiment, an electrode may be formed using no graphite.

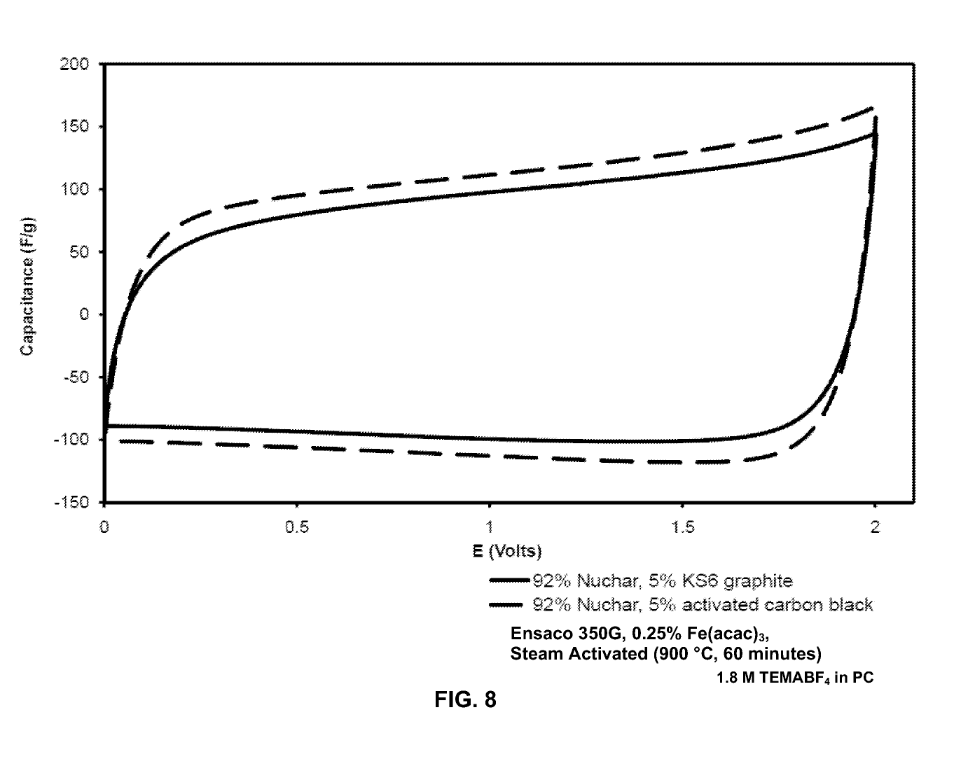

Activated carbon blacks may also be combined with activated carbons to form electrodes. FIG. 8 is a graph showing a cyclic voltammogram of an activated carbon blended with graphite, compared with an activated carbon blended with an activated carbon black.

In one experiment, ordinary (inexpensive) commercial MeadWestvaco Nuchar® chemically activated filtration carbon (available from MeadWestvaco Corporation, Covington, Va.) is steam activated at 850° C. for 30 minutes. During the steam activation, nitrogen is flowed through the furnace to purge or remove air. The nitrogen purge continues as the water is injected into the furnace. The water is introduced into the furnace using a metering pump. The nitrogen flow rate is held at about 200 mL/min and the water injection rate is held at approximately between 150 and 175 mL/h. This steam activation may also be referred to as 30% steam activation, where 30% is the approximate molecular weight fraction of water (steam) flowed through the furnace as a proportion of the total gas flow.

Ensaco 350G carbon black is activated by solvent deposition of 0.25% (metal:carbon weight) iron acetylacetonate dissolved in tetrahydrofuran (THF) onto a sample of Ensaco 350G, followed by evaporation of the solvent and then initial metal oxide nanoparticle and catalytic mesopore formation using a steam activation at 900° C. for 60 minutes. A first electrode is formed utilizing 92 wt. % activated Nuchar, 5 wt. % KS6 graphite, and 3 wt. % Teflon PTFE 6C binder, and a second electrode is formed utilizing 92 wt. % activated Nuchar, 5 wt. % activated Ensaco 350G, and 3 wt. % Teflon PTFE 6C binder. Specific capacitance results for each sample electrode as measured in using 1.8M TEMABF₄ in PC electrolyte are shown in Table 6.

TABLE 6

| | | 92% Activated Nuchar, |
|---|---|---|
| | | 30 min. Steam at 850° C. |
| | | 5% Ensaco 350G, |
| | 92% Activated Nuchar, | 0.25% Fe(acac)₃ |
| | 30 min. Steam at 850° C. | in THF, 60 min. |
| | 5% KS6 graphite | Steam at 900° C. |
| Specific | 98.5 F/g | 112.2 F/g |
| Capacitance | | |
| (1 V) | | |
| Specific | 107.2 F/g | 123.6 F/g |
| Capacitance | | |
| (1.5 V) | | |

The specific capacitance of KS6 graphite is approximately two orders of magnitude lower than the activated carbon in Table 6 (see F. Joho, M. E. Spahr, H. Wilhelm, P. Novak, The Correlation of the Irreversible Charge Loss of Graphite Electrodes with their Double Layer Capacitance, PSI Scientific Report 2000/Volume V, General Energy, 69-70, 70 (Paul Scherrer Institut, March 2001), reporting 0.769 F/g specific capacitance of KS6 graphite in 1M M LiPF₆, EC:DMC (1:1) electrolyte). This is consistent with the relatively low BET surface area of KS6 graphite (20 m²/g according to the manufacturer data sheet). Therefore, the increase in specific capacitance can be attributed to the use of activated carbon black in the electrode. Similarly, an improvement in specific capacitance of an activated carbon/carbon black electrode may be achieved by substituting an activated carbon black in place of a similar percentage content of the non-activated carbon black.

In other embodiments, activated carbon blacks may be utilized in electrodes containing other types of activated carbons formed from a variety of carbon and carbon precursor materials, such as Kynol fiber precursor (available from American Kynol, Inc., Pleasantville, N.Y.). The carbon material may be activated utilizing other thermal activation or general nanoparticle catalytic activation methods, where the nanoparticle deposition on the carbon may be performed by techniques such as general solvent coating methods using organometallic precursors followed by thermal decomposition into nanoparticles, or electrodeposition as described in U.S. patent application Ser. No. 12/118,413, filed May 9, 2008, the entire contents of each are incorporated herein by reference, except that in the event of any inconsistent disclosure or definition from the present application, the disclosure or definition herein shall be deemed to prevail.

Where an activated carbon black has equal or similar specific capacitance to an activated carbon, the proportions of each utilized to form the electrode may be varied without negatively impacting gravimetric capacitance. Thus, the percentage of activated carbon black may be increased as necessary to lower ESR to a desired value, without reducing the gravimetric capacitance of the electrode.

Further, the proportion of activated carbon black may be increased in order to fill voids in the activated carbon material, improving volumetric capacitance without negatively effecting gravimetric capacitance. This may complement the use of pressure rolling an electrode to reduce voids during the manufacturing process, or may eliminate the need for pressure rolling altogether. Using activated carbon black to fill voids displaces surplus costly electrolyte that may be unnecessary for Helmholtz layer capacitance, including ion mobility. In one embodiment, the approximate minimum quantity of electrolyte may be determined by increasing the proportion of activated carbon black, and decreasing the amount of electrolyte utilized, until the specific capacitance of an electrode begins to decrease. Utilizing this experiment, it is assumed that the decrease in specific capacitance is at least partially attributable to having insufficient electrolyte to form a Helmholtz layer on all of the carbon and carbon black surface area available. In another embodiment, the approximate minimum quantity of electrolyte may be determined by increasing the proportion of activated carbon black, and decreasing the amount of electrolyte utilized, until the measured ESR of an electrode begins to increase. Utilizing this experiment, it is assumed that the increase in ESR is at least partially attributable to ion mobility being inhibited because of insufficient electrolyte solvent. In yet another embodiment, the approximate minimum quantity of electrolyte may be determined by increasing the proportion of activated carbon black, and decreasing the amount of electrolyte utilized, until the specific capacitance of an electrode begins to decrease, or until the ESR of an electrode begins to increase.

This invention discloses a novel conductive material created through activation of conductive carbon blacks utilizing methods of engineered nanoparticle deposition. The nanoparticles may serve as catalysts for activation rugosity of carbon blacks. The activated carbon black material has specific capacitance significantly greater than the specific capacitance of non-activated carbon black material. Moreover, because the specific capacitance of activated carbon blacks may be equal or comparable to the specific capacitance of many activated carbon materials, activated carbon blacks may be combined with activated carbons while partially or completely avoiding the gravimetric capacitance penalty sometimes associated with adding non-activated conductive carbon blacks to activated carbons when manufacturing EDLCs. Whereas typically less than 10% proportion of carbon black is utilized in an EDLC in order to minimize the negative impact on gravimetric capacitance, activated carbon blacks may be combined with activated carbon in far greater proportions. In one embodiment, an EDLC may contain activated carbon black material, and no activated carbon material.

In some embodiments, the volumetric capacitance of an activated carbon black may be lower than the volumetric capacitance of an activated carbon. As a consequence, the volume of an EDLC containing activated carbon black material, and no activated carbon material, may be greater than the volume an EDLC (of equal charge storage capacity) containing higher proportion of activated carbon. While greater volumetric capacitance is desirable in many applications, there are some applications where volumetric capacitance is a secondary design consideration. In those applications, a higher proportion of activated carbon black may be utilized despite the increased volume of the resulting EDLC. For example, an EDLC containing activated carbon black material, and no activated carbon, may be utilized in some design applications despite the lower volumetric capacitance of an activated carbon black material.

EDLCs are sometimes fabricated using a polydispersion of activated carbon particles with a wide range of sizes in order to fill the voids introduced by random packing of activated carbon particles. By filling voids with activated carbon material, volumetric capacitance may be increased. However, as previously discussed, this technique may fill voids at the expense of increased grain boundary resistance, and hence, increased ESR of the finished EDLC, and lower power density. As noted above, activated carbon black material may be added in greater proportions because of its improved specific capacitance. Hence, activated carbon black may be used to fill the voids commonly found in activated carbons. By using activated carbon black material to fill voids, the activated carbon material may be air-classified to reduce fines, as a polydisperse distribution of activated carbon particle sizes may no longer be as necessary in order to fill voids. Hence, by utilizing activated carbon black material to fill voids, volumetric energy density may be improved without sacrificing power density.

Electrolyte added to an EDLC during the manufacturing process may fill voids in the activated carbon material. Any electrolyte used in an EDLC beyond what is required to cover the surface available for Helmholtz layer capacitance and facilitate ion mobility is surplus. By using activated carbon black to fill voids in activated carbon, surplus electrolyte is displaced. Therefore, the amount of unnecessary surplus electrolyte contained in an EDLC may be reduced by utilizing activated carbon blacks to fill voids. As an additional benefit, by filling voids with activated carbon black material, volumetric capacitance is increased. Experimentally, the amount of surplus electrolyte may be determined by increasing the volume of activated carbon black (and decreasing the volume of electrolyte by the same amount) until the specific capacitance of the manufactured EDLC decreases, where the decrease in specific capacitance is assumed to be at least partially attributable to having insufficient electrolyte to form a Helmholtz layer on all of the carbon and carbon black surface area available. If ion mobility is inhibited by lack of electrolyte, ESR may increase. Therefore, the amount of surplus electrolyte may also be experimentally determined by increasing the volume of activated carbon black (and decreasing the volume of electrolyte by the same amount), until the ESR of the manufactured ELDC stops decreasing and begins again to increase, attributable at least in part to insufficient solvent to permit facile ion migration between the two electrodes.

Finally, activated carbon black material is still conductive, and therefore, may be utilized to lower grain boundary resistance, and hence, the ESR of EDLCs. The activation process may increase the sheet resistivity of the activated carbon black because of the surface rugosity and mesopores created, and therefore reduce the ability of activated carbon black to reduce ESR. However, the improved specific capacitance of activated carbon black material allows an increased proportion of activated carbon black to be added in order to offset this effect (if any). As stated before, depending on the specific capacitance of the activated carbon and activated carbon black material, adding more activated carbon black may have little or no negative effect on the gravimetric capacitance of the EDLC.

The catalytically activated carbon black material may be used in all manner of devices that contain carbon or carbon black materials, including various electrochemical devices (e.g., capacitors, batteries, fuel cells, and the like), hydrogen storage devices, filtration devices, catalytic substrates, and the like.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. A device, comprising:
an activated carbon; and
an activated carbon black.

2. The device of claim 1, wherein a proportion of activated carbon to activated carbon black is less than 10:1.

3. The device of claim 1, wherein the device is an electrochemical device, a capacitor, a hydrogen storage device, a filtration device, or a catalytic substrate.

4. The device of claim 1, wherein the device is a capacitor, the activated carbon has a specific capacitance of at least 80 F/g, and the activated carbon black has a specific capacitance of at least 80 F/g.

5. The device of claim 1, wherein the device is a capacitor, and a specific capacitance of the activated carbon black is at least 80 F/g.

6. A device, comprising:
an activated carbon black, wherein a specific capacitance of the activated carbon black is at least 80 F/g.

7. The device of claim 6, wherein the device is an electrochemical device, a capacitor, a hydrogen storage device, a filtration device, or a catalytic substrate.

8. A method of forming an activated carbon black comprising:
(a) providing a carbon black;
(b) coating the carbon black with nanoparticles; and
(c) catalytically activating the carbon black in steam and an inert gas to form a catalytically activated carbon black; wherein the mass of the catalytically activated carbon black is lower than the mass of the carbon black, and wherein the activated carbon black is mesoporous.

9. The method of claim 8, wherein the activated carbon black has a specific capacitance of at least 80 F/g.

10. The method of claim 8, wherein the activated carbon black has a specific capacitance of at least 110_F/g.

11. The method of claim 8 wherein the carbon black comprises aggregates having at least one dimension of less than 1000 nanometers.

12. The method of claim 8, wherein the nanoparticles comprise a metal.

13. The method of claim 8, wherein the nanoparticles comprise at least two different metal oxides.

14. The method of claim 8, wherein the nanoparticles comprise iron, nickel, cobalt, titanium, ruthenium, osmium, rhodium, iridium, yttrium, palladium platinum, zirconium, or combinations thereof or alloys thereof.

15. The method of claim 12 wherein the nanoparticles comprise iron, nickel, cobalt, titanium, ruthenium, osmium, rhodium, iridium, yttrium, palladium platinum, zirconium, or combinations thereof or alloys thereof.

16. The method of claim 8, wherein a total mass loss of the carbon black after step c is greater than about 50%.

17. A material comprising the activated carbon black made by the method of claim 8 and a binder.

18. A device containing the activated carbon black of claim 8.

19. A device containing the material of claim 17.

20. The device of claim 19, wherein the device is an electrochemical device, a capacitor, a hydrogen storage device, a filtration device, or a catalytic substrate.
